(19) United States
(12) Patent Application Publication
(10) Pub. No.: US 2018/0060960 A1
(43) Pub. Date: Mar. 1, 2018

(54) SYSTEM AND METHOD FOR EXCHANGING DIGITAL BEARER INSTRUMENTS

(71) Applicant: LAZLO 326, LLC, Jacksonville, FL (US)

(72) Inventor: Michael C. Pinkus, Duluth, GA (US)

(21) Appl. No.: 15/680,576

(22) Filed: Aug. 18, 2017

Related U.S. Application Data
(60) Provisional application No. 62/378,266, filed on Aug. 23, 2016.

(51) Int. Cl. G06Q 40/04

(52) U.S. Cl. CPC G06Q 40/04

(57) ABSTRACT

A system and method of exchanging a first bearer instrument in the form of a first digital electronic file for a second bearer instrument in the form of a second digital electronic file. The system includes the use of a personal electronic device (12) that communicates with an exchange authority (14). The exchange authority, in turn, communicates with a validation authority (16) to verify or validate the first bearer instrument and an issuing authority (18) which issues a second bearer instrument.

### REFERENCE TO RELATED APPLICATION

Applicant claims the benefit of U.S. Provisional Patent Application Ser. No. 62/378,266 filed Aug. 23, 2016 and entitled A SYSTEM AND METHOD FOR DIGITALLY EXCHANGING ANONYMOUS BEARER INSTRUMENTS FOR ANONYMOUSLY REDEEMABLE INSTRUMENTS OF LIKE VALUE.

### TECHNICAL FIELD

This invention relates generally to a system and method of exchanging bearer instruments, and more particularly to a system and method of exchanging bearer instruments in the form of anonymous digital bearer instruments.

### BACKGROUND OF INVENTION

Bearer instruments may be in a number of different forms. A bearer instrument may be in the form of a bond, a gift card, a lottery ticket, or similar instrument. Currently, paper and other physical lottery tickets and other similar anonymous bearer instruments can only be claimed anonymously for cash value from authorized retail or issuing authority locations. Often, finding physical locations with the on-hand cash or desire to redeem a ticket with issuer validated cash value can be difficult. As such, it would be a benefit to provide a system that would allow a mobile or web based system to anonymously redeem those tickets possessing issuer validated cash value. However, some people may wish to exchange the lotter ticket for a gift card or other type of bearer instrument rather than receiving cash. As such, it would be a benefit to provide a system for exchanging a lottery ticket, or other type of bearer instrument, for another bearer instrument which may be of similar value without having to travel to a physical location to make the exchange.

Other systems provide means to transfer value from identity tied instruments (wager wins after player registered to play on a web site or service) to other identity tied instruments (like credit or debit cards or other non-bearer instruments), but the ability to remain anonymous or have the option to remain anonymous is a key trait of traditional bearer instrument and specifically ticket claims. Particularly smaller claims (known as low tier claims in the lottery industry) where a tickets awarded value can be exchanged for cash without presenting identification.

Exchanges have also existed wherein a person may exchange a gift card from one merchant for the gift card of another merchant or for cash. These exchanges utilize kiosk or other machines which accept the gift card in physical form rather than in purely digital form, i.e., the presence of a physical gift card is required. Thus, the person must again travel to a location having the exchange machine and must present a physical card in order to complete the transaction.

Accordingly, it is seen that a need remains for a system and method for the digital bearer instrument exchange for another digital bearer instrument. It is to the provision of such therefore that the present invention is primarily directed.

### SUMMARY OF THE INVENTION

Currently, paper and other physical lottery tickets and other similar anonymous bearer instruments like gift cards and coupons can only be claimed anonymously for cash value from authorized retail or issuing authority locations. Often, finding physical locations with the on-hand cash or desire to redeem a ticket with issuer validated cash value can be difficult. The system proposed would allow a mobile or web based system to redeem those instruments possessing issuer validated cash value and to be exchanged for other instruments or items of like value without having to travel to a physical location to do so.

Winning lottery tickets are anonymous bearer instruments with cash value claimed by possession of the ticket. A system is proposed to redeem lottery tickets with validated cash value from bearers of those lottery tickets in exchange for anonymous gift cards, digital gift codes, merchandise, events and other instruments of equal purchasing value.

Other systems provide means to transfer value from identity tied instruments (wager wins after player registered to play on a web site or service) to other identity know instruments (like credit or debit cards or other non-bearer instruments), but the ability to remain anonymous or have the option to remain anonymous is a key trait of traditional bearer instrument (gift card, coupon, ticket) claims. Particularly smaller claims where an Instrument can be exchanged for cash without presenting identification.

The system would allow a bearer to relinquish the right to claim on these first bearer instruments electronically in exchange for second (redeemable) instruments selected by the bearer. These second instruments could be gift cards or barter services or any item or service of value which can be represented by a redeemable instrument.

A method of exchanging a first digital bearer instrument for a second digital bearer instrument comprises the steps of providing a first digital bearer instrument in the form of a first digital electronic file on a personal electronic device, transferring the first digital electronic file from the personal electronic device to an exchange authority, in response to the exchange authority receiving the first digital electronic file, the exchange authority transfers the first digital electronic file to a validation authority, validating the first digital electronic file by the validation authority for authenticity and value, in response to the validating of the first digital electronic file, the validation authority responding to the exchange authority with authenticity and value indicators, in response to receiving a positive validation from the validation authority, the exchange authority requesting a second digital bearer instrument of specific value from an issuing authority, in response to receiving a request for a second digital bearer instrument from the exchange authority, the issuing authority issuing a second digital bearer instrument and transferring the second digital bearer instrument in the form of a second digital electronic file to the exchange authority, the exchange authority invalidating the first digital bearer instrument, the exchange authority records the second digital bearer instrument, the exchange authority causing payment to be made to the issuing authority for the second bearer instrument, and the exchange authority transferring the second digital bearer instrument in the form of a second digital electronic file to the personal electronic device.

### BRIEF DESCRIPTION OF DRAWINGS

FIG. 1 is a schematic view of a system and method for exchanging digital bearer instruments embodying principles of the invention in a preferred form.

FIG. 2 is a schematic view of a system and method of exchanging digital bearer instruments embodying principles of the invention in another preferred form.

FIG. 3 is a schematic view of a system and method of exchanging digital bearer instruments embodying principles of the invention in another preferred form.

FIG. 4 is a schematic view of a system and method of exchanging digital bearer instruments embodying principles of the invention in yet another preferred form.

### DETAILED DESCRIPTION

In one implementation, and as an example, a lottery ticket (anonymous digital bearer instrument) could be traded or exchanged for a gift card or code (another anonymous digital bearer instrument) provided by a retailer or retailer authorized financial processor. The means of trade would be the acknowledgement by the bearer in a manner acceptable to the bearer and the lottery issuing authority such that the entity employing the system would become the legal bearer of the lottery ticket or be classified as the redemption agent after the transfer takes place. The lottery issuing authority might require that the entity employing the system perform a background check to assure that the bearer has no outstanding debts or authority liens prior to cashing the bearer instrument. The system could then require that the bearer provide such information so as to comply with the requirements such that the fees or liens could be satisfied as a part of a simultaneous transaction facilitated by the system and resulting in the entity operating the system becoming the bearer of the ticket and due the full value of the ticket having satisfied the fees or liens on behalf of the original bearer. The system might employ image optical character recognition to gather photo identification information from a valid photo id to be included in the contract of exchange. The system might employ facial or other biometric recognition to be included in the contract of exchange.

The original bearer could be provided an audited receipt able to represent the change of ownership and receipt of value in return for the transfer of ownership. The value transferred does not need to be cash but any instrument of value equal to or made in exchange for the original cash value of the bearer instrument. The lottery issuing authority receives validated and non-repudiated proof of transfer which is entered into the ledgers of the lottery issuing authority such that the new bearer becomes the bearer of record or acts as the agent of redemption. This could be through issuance of a new bearer instrument to the new bearer/agent or through acknowledgement of the transaction with the original bearer instrument retaining its value with the new bearer/agent. This exchange does not need to mean the lottery issuing authority has been presented the original bearer instrument for claim, it may only mean the exchange provider has validated the ticket value with the lottery authority and then assumed bearer status/ownership of an unclaimed, but validated ticket value.

In one implementation, the original (lottery ticket) bearer might provide on a mobile phone app, personal identifying information such as name and address and social security number and digital signature to prove the transfer validity. In another implementation, the original (lottery ticket) bearer might provide personal identifying information such as face print or biometric identifiers to prove the transfer validity. In another implementation the original (lottery ticket) bearer may provide no personal identifying information but instead may rely on common encryption and digital signature processes to establish a legally binding contract of transfer on the bearer instrument acceptable to the issuing authority and/or authorized retailer.

The ticket may be a digital bearer instrument and the bearer may possess the ticket on a mobile phone and wish to cash the ticket with a commercial entity in return for a gift card of equal or unequal value. The bearer would indicate the desire to claim the value and choose a gift card from a possible list of several gift cars (bearer instruments). The system would validate the winning status and value of the bearer instrument with the lottery issuing authority. If the lottery ticket is found to be valid, the system then requests personal information and agreement to terms to provide validity to the transfer of the digital bearer instrument to the entity operating the system in return for the physical gift card or digital bearer code being provided to the original bearer. The digital bearer instrument (lottery ticket) would then be owned by the entity and presented simultaneously or at a later date to the ticket issuing authority for its full cash value.

The ticket may be a digital bearer instrument and the bearer may possess the ticket on a mobile phone in electronic file format and wish to cash the ticket through an exchange entity in return for physical merchandise of equal or unequal value. The bearer would indicate the desire to claim the value and choose a merchandise item from a possible list of several merchandise. The system would validate the winning status and value of the bearer instrument with the lottery issuing authority. If the lottery ticket is found to be valid, the system then requests personal information, possible shipping information and agreement to terms to provide validity to the transfer of the digital bearer instrument to the exchange entity operating the system in return for the physical merchandise being provided to the original bearer. The digital bearer instrument (lottery ticket) would then be owned by the exchange entity and presented simultaneously or at a later date to the ticket issuing authority for its full cash value.

In the event that the ticket bearer instrument is a digital bearer instrument, the system provides an application interface to manipulate the bearer instruments and direct selection mechanism of possible exchange items (bearer instruments) following the indication in the application by the bearer that they wish to claim the value of the bearer instrument.

The exchanged value may be the total or partial value of a shopping cart (bearer instruments) or of merchandise selected by the bearer on one or more merchant shopping systems. The bearer instrument value would be traded for the merchandise selected.

Today, the bearer possessing a paper ticker presents it for redemption at an authorized retailer (store) which validated its authenticity of value with a validation authority which then returns the value due the bearer to the authorized retailer which pays cash to the bearer.

When using invention the system and method allows a bearer possessing a digital ticket (digital bearer instrument) stored within a phone or other computer or data storage system to present it for redemption with an authorized exchange central system or exchange authority which validates its authenticity and value with a validation authority and then returns the value due the bearer to the authorized exchange central system (exchange authority) which then pays a value equal to the value due the bearer.

A system is claimed that can accept anonymous bearer instruments in a means acceptable to the issuing authority and to exchange those bearer instruments for other anonymous bearer instruments.

Further the system may utilize a mobile phone or other computing device capable of storing anonymous bearer instruments (like lottery tickets) in a manner acceptable to the issuer (like the lottery) and to confirm the existence of value on those instruments through digital means of request and reply from the issuing authority.

Further, the system capable of interfacing through digital means of request and reply with an issuer of alternate anonymous bearer instruments (like gift cards and similar) such that the system can both validate a first anonymous bearer instruments value and at the same time request through digital means of request and reply from the issuer of alternate anonymous bearer instruments (like gift cards and similar instruments) a second bearer instrument containing the same or different value and to cause them to be exchanged in a non-repudiable manner.

The system where anonymity exists after the transaction between the first bearer and the issuing authority of the first bearer instrument and also exists after the transaction between first bearer and the issuing authority of the second bearer instrument.

The transfer of digital bearer instruments for validation and amount, as well as other information, is disclosed in U.S. patent application Ser. No. 14/612916 to Pinkus, the disclosure of which is incorporated herein by reference in its entirety.

The term exchange authority is intended to mean an entity or authority which controls the exchange of one bearer instrument for another bearer instrument.

The term validation authority is intended to mean an entity which validates (authenticates and/or establishes the value) the a bearer instrument (may be the original or first bearer instrument initiating the exchange).

The term issuing authority is intended to mean an entity or authority which controls the issuing of a bearer instrument (may be the new or second bearer instrument received after the exchange is complete).

As a first example, shown in FIG. 1, there is shown a lottery ticket 10 (original bearer instrument) having already been purchased and stored as an anonymous digital bearer instrument (first or original digital file) on an electronic device 12 such phone, pda, laptop, computer, or the like. The person initiates contact with an exchange authority 14 through cellular service or wireless service through the internet, wherein the anonymous digital file is transferred from the phone (electronic device 12) to the exchange authority 14. As an equivalent alternative to the transfer of an entire electronic file, the transfer of metadata associated with the electronic file may be utilized for all purposes recited herein.

The exchange authority 14 receives the digital file (digital bearer instrument) and relays or transfers the first or original digital file (digital bearer instrument) to a validation authority 16. The validation authority 16 receives the digital file (digital bearer instrument), verifies or validates the authenticity of the digital file (digital bearer instrument), and determines the value of the digital file (digital bearer instrument). The validation authority 16 then responds to the exchange authority 14 regarding the authenticity and value of the digital file (digital bearer instrument) if authenticity is determined to be valid, i.e., the validation authority provides authenticity and value indicators to the exchange authority.

The exchange authority 14 then relays or contacts the phone (electronic device 12) that the verification or validation has been approved, assuming the bearer instrument has been determined to be valid, wherein the person may then select the option of redeeming the original bearer instrument for a second, another, or different digital bearer instrument. The second digital bearer instrument may be in the form of a gift card, coupon, store credit, voucher, or other digital bearer instrument. The person then selects the type of second bearer instrument he or she would like to exchange for the first or original bearer instrument and the specific value associated with the second bearer instrument. The selection and specific value is then transmitted from the phone (electronic device 12) to the exchange authority 14. The second bearer instrument is transferred in the form of a second electronic file.

The exchange authority 14 receives the transmitted request for the second bearer instrument and contacts the issuing authority 18 associated with that second bearer instrument. For example, if the second bearer instrument is for a gift card from Store ABC, the exchange authority 14 contacts the issuing authority 18 in charge of issuing Store ABC gift cards. The issuing authority 18 then processes the request for the second bearer instrument and transmits the data for such back to the exchange authority 14, i.e., the issuing authority 18 issues the second bearer instrument in digital file format.

The exchange authority 14 then relays or transmits the second bearer instrument (digital file) to the phone (electronic device 12) where it may be stored in digital file format. The exchange authority 14 also invalidates the original bearer instrument so that it cannot be redeemed again. The exchange authority 14 retains ownership and thus the value of the second bearer instrument and causes payment to be made to the issuing authority.

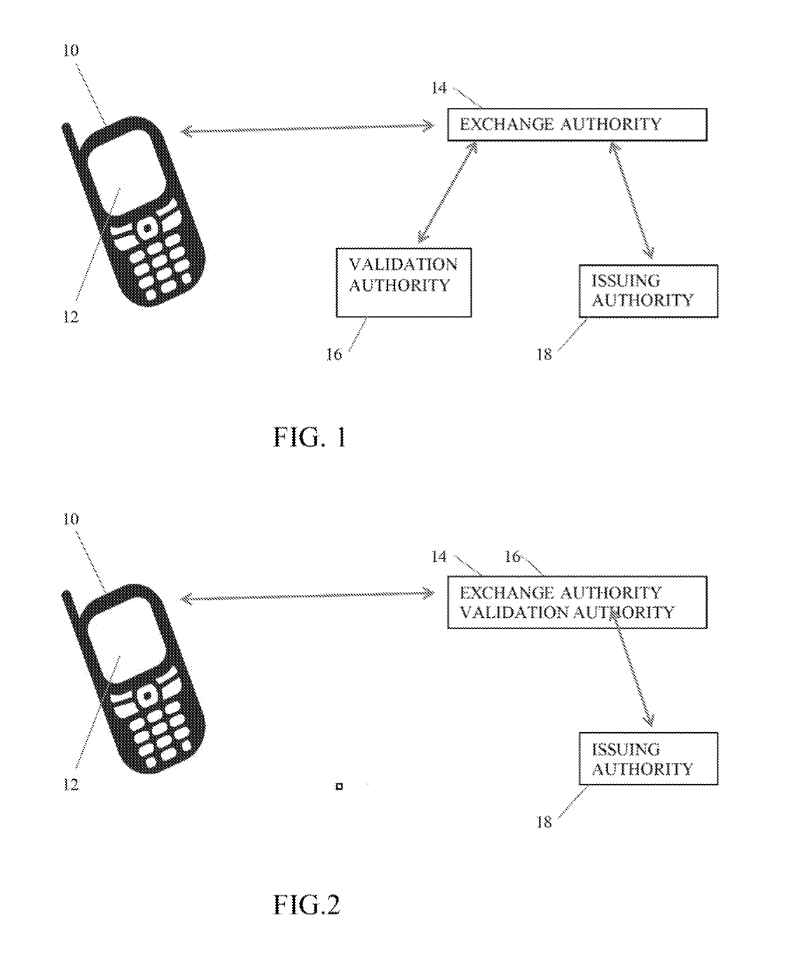

With reference next to FIG. 2, there is shown a schematic diagram of the system and method in another preferred form of the invention. Here, the system and method are essentially the same as that previously described in reference to FIG. 1 except that the exchange authority 14 and the validation authority 16 is shown as a single entity or contact. An example of such a system may be where a lottery authority is acting as the exchange authority, i.e., the lottery authority is acting as an exchange authority for secondary bearer instruments and the validation authority for verifying or validating the authenticity and value of a lottery ticket (first or original bearer instrument). The lottery system (combination exchange authority and validation authority) still communicates with an issuing authority 18 to produce, create, or establish the second bearer instrument issued by the issuing authority 18.

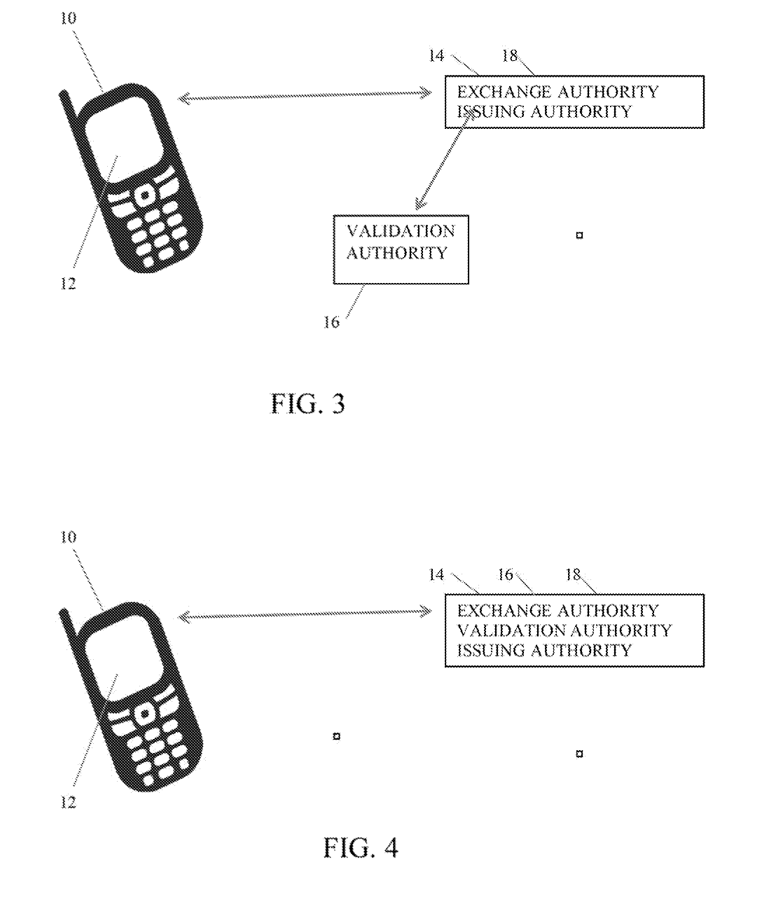

With reference next to FIG. 3, there is shown a schematic diagram of the system and method in another preferred form of the invention. Here, the system and method are essentially the same as that previously described in reference to FIG. 1 except that the exchange authority 14 and the issuing authority 18 is shown as a single entity or contact. An example of such a system may be where a lottery authority is acting as the exchange authority, i.e., the lottery authority is acting as an exchange authority for first or original bearer instruments and the issuing authority for issuing a second bearer instrument. For example, the lottery authority is issuing second bearer instruments in exchange for the submission of the first bearer instrument. The exchange authority 14 still verifies or validates the first or original bearer instrument through communications with the validation authority.

With reference next to FIG. 4, there is shown a schematic diagram of the system and method in another preferred form of the invention. Here, the system and method are essentially the same as that previously described in reference to FIG. 1 except that the exchange authority 14, the issuing authority 18, and the validation authority 16 are all shown as a single entity or contact. An example of such a system may be where a lottery authority is acting as the exchange authority, as the validation authority 16 verifying or validating the authenticity and value of a lottery ticket (first or original bearer instrument) and the issuing authority 18 which is issuing the second bearer instrument made in exchange for the first bearer instrument.

Through the various examples previously described, it should be understood that the exchange authority 14, validation authority 16 and issuing authority 18 may be separate and distinct entities or may be combined logically, physically, or otherwise.

The communications or electronic file transfers between the personal electronic device and the authorities, or between authorities, is conventional and need not be described in detail herein. It is also understood that the files may be encrypted. Lastly, it should be understood that the verification or validation process may be done so through a verification or validation of the hash associate with the electronic file, which is considered an equivalence herein.

It thus is seen that a method and system for a novel improvement to the bearer instrument claims process allowing a bearer to redeem value in a cashless manner and using a device not present at the physical retail location is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention.

1. A method of exchanging a first digital bearer instrument for a second digital bearer instrument comprising the steps of:
a. providing a first digital bearer instrument in the form of a first digital electronic file on a personal electronic device;
b. transferring the first digital electronic file or metadata of first digital electronic file from the personal electronic device to an exchange authority;
c. in response to the exchange authority receiving the first digital electronic file or metadata of first digital electronic file, the exchange authority transfers the first digital electronic file or metadata of first digital electronic file to a validation authority;
d. validating the first digital electronic or metadata of first digital electronic file by the validation authority for authenticity and value;
e. in response to the validating of the first digital electronic file or metadata of first digital electronic file, the validation authority responding to the exchange authority with authenticity and value indicators;
f. in response to receiving a positive validation from the validation authority, the exchange authority requesting a second digital bearer instrument of specific value from an issuing authority;
g. is response to receiving a request for a second digital bearer instrument from the exchange authority, the issuing authority issuing a second digital bearer instrument and transferring the second digital bearer instrument in the form of a second digital electronic file to the exchange authority;
h. the exchange authority invalidating the first digital bearer instrument;
i. the exchange authority records the second digital bearer instrument;
j. the exchange authority causing payment to be made to the issuing authority for the second bearer instrument, and
k. the exchange authority transferring the second digital bearer instrument in the form of a second digital electronic file to the personal electronic device.

2. The method of claim 1 wherein the validation authority is a lottery system authority.

3. The method of claim 2 wherein the issuing authority is a merchant gift card authority.

4. The method of claim 1 wherein the issuing authority is a merchant gift card authority.

5. The method of claim 1 wherein the issuing authority is a physical merchandise or physical service providing authority.

6. The method of claim 1 wherein the validation authority is a merchant gift card authority.

7. The method of claim 1 wherein the exchange authority is a lottery system authority.

8. A method of exchanging a first digital bearer instrument for a second digital bearer instrument comprising the steps of:
a. providing a first digital bearer instrument in the form of a first digital electronic file on a personal electronic device;
b. transferring the first digital electronic file from a personal electronic device to an authority;
c. validating the first digital electronic file for authenticity and value;
d. in response to receiving a positive validation, the authority issuing a second digital bearer instrument, transferring the second digital bearer instrument in the form of a second digital electronic file to the personal electronic device, and invalidating the first digital bearer instrument, and
e. the authority recording the second digital bearer instrument and making payment to an entity associated with the second digital bearer instrument.

9. The method of claim 8 wherein the authority is a lottery system authority.

10. The method of claim 8 wherein the authority is a merchant gift card authority.

11. The method of claim 8 wherein the issuing authority is a physical merchandise or physical service providing authority.
